(19) United States
(12) Patent Application Publication
(10) Pub. No.: US 2010/0145525 A1
(43) Pub. Date: Jun. 10, 2010

(54) METHOD AND CIRCUIT ARRANGEMENT FOR SECURE CONTROL OF ACTUATORS, SENSORS AND/OR USERS IN AN ELECTRICAL DEVICE COMPRISING THE SAME IN PARTICULAR IN AN ELECTRICAL DOMESTIC APPLIANCE

(75) Inventors: Hasan Gökcer Albayrak, Berlin (DE); Guido Sattler, Falkensee (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH BOSCH UND SIEMENS HAUSGERÄTE GMBH, Munich (DE)

(21) Appl. No.: 12/513,534

(22) PCT Filed: Oct. 31, 2007
(86) PCT No.: PCT/EP07/61730

§ 371 Date: Dec. 21, 2009

(30) Foreign Application Priority Data
Nov. 8, 2006 (DE) 10 2006 052 739.9

(51) Int. Cl. G05B 11/01

(52) U.S. Cl. 700/275; 700/12

(57) ABSTRACT

A method for secure control of one of actuators, sensors, and loads in an electrical appliance, with at least two switch bodies operated in accordance with an AND logic gate for effective switching of the one of actuators, sensors, and loads by control signals acting on the at least two switch bodies. A continuous signal and a pulse signal are issued as control signals to a number of bistable control bodies corresponding to a number of the switch bodies, which are put into a switched-on state only by issuing the continuous signal and the pulse signal which occurs during issuing of a relevant continuous signal, in which the switch bodies are effectively switched, and put into a switched-off state in which the switch bodies are switched off solely by switching off the continuous signal and kept in this switched-off state even if the relevant continuous signal is issued once more.

The invention relates to a method and a circuit arrangement for secure control of actuators, sensors and/or loads in an electrical appliance containing these components, especially in a electrical domestic appliance with at least two corresponding switch bodies operated in accordance with an AND logic gate for effective switching of said actuators sensors or loads by control signals acting on the switch bodies.

In electrical appliances it can be necessary to monitor the assumption of specific operating states in a particular way. Such an operating state is for example the secure switching off of actuators, sensors or loads after a door of such an appliance has been opened, such as especially an electrically-operated washing machine or an electrically-operated tumble dryer, and the maintenance of the switched-off state after the door has been closed again and remains in this state until a renewed switching on of the actuators, sensors or loads can be permitted by scheduling in response to a user request. In electronic controllers for electrical appliances, such as domestic appliances for example, so called protected electronic circuits—also referred to as PECs—usually prevent these types of critical appliance state. Usually software is used to ensure that such critical appliance states cannot occur. Thus the software itself becomes a component of a PEC. The orderly functioning of the software has to be qualified in relatively complex methods and tests however. It is thus highly desirable to avoid this effort or at least to reduce it.

An electronic switch with two transistors in series, e.g. for switching on a motor for the volume control in a sound reproduction device is already known (DE 35 17 030 A1). With this known electronic switch the bases of the two known transistors are decoupled such that a switching current reaches both bases, but with an impermissibly low-resistance bridging of the electrodes of one transistor the other transistor does not become conductive. This prevents the entire switch becoming conductive during a short circuit of the electrodes of one transistor. This known switch is not suitable however for use in the way considered above.

There is also another so-called redundant secure switching device known for switching a load (EP 1 131 684 B1=DE 699 05 751 T2). This known secure switching device contains a circuit arrangement in which there is a load on a supply voltage via two series-connected switches. A resistance is switched in parallel to the one switch connected to one pole of a supply voltage source. Connected to this resistor is an error detector which allows it to be established, on the basis of the voltage dropping at the relevant resistor, whether the two switches are operating correctly or whether and if necessary which of the two switches is operating incorrectly, i.e. is either short circuited or interrupted. Thus with the relevant known secure switching device the control facility of the switch is fail-safe or operationally safe during the deactivation. Expressed in other words this means that the known secure switching device involves a secure switching off of the load in the event of occurrence of errors in the switches and the controller. To this end the controller mentioned includes a sequencing device which, on activation, first switches a first control signal, which is especially a pulse signal, to the first control output which controls the one switch which is not switched in parallel to the resistor mentioned, and a specific period of time thereafter feeds a second control signal, which is especially a direct current signal, to the second control output, meaning that in doing so it controls the second switch in the sense of closing it. This enables the functional integrity of the two switches to be monitored.

The previously-mentioned load is thus disconnected in each case from the supply voltage if at least one of the two control signals fails; In this case it is namely the switching path defined by the two said switches that is interrupted. The relevant known safe switching device is not suitable however for through-switching of the switching path concerned by the control signals, of which one is a pulse signal and the other is a continuous signal and for a subsequent interruption of the switching path merely by switching off the continuous signal mentioned.

There is also a known secure switching arrangement for control of a safety relay of an electronically-regulated braking system of a motor vehicle (DE 39 24 988). This known circuit arrangement has at least two transistors connected in series with their switching paths and a test circuit which blocks the transistors on occurrence of an error type or a fault. The functional capability of the transistors and the test circuit is checked at regular intervals, e.g. each time the ignition of the motor vehicle engine is switched on. The failure of one of the transistors or of the test circuit leads to the security relay being switched off. However the relevant known security arrangement is not suitable for secure through switching of the said switching path by control signals, of which one is a pulse signal and of which another is a continuous signal, as well as for a subsequent interruption merely by switching off the said continuous signal, since in the relevant known security circuit arrangement the two said signals are similar-type signals.

Finally a method and a circuit arrangement for secure control of actuators, sensors or loads in an electrical appliance containing these components, especially in an electrical domestic appliance, has already been proposed (DE 10 2005 034 911.0), which has a controller from which a special signal or pulse sequence exhibiting a specific characteristic is only additionally issued if the relevant electrical appliance is operating correctly, of which the occurrence is monitored. In such cases, only when such a special signal or pulse sequence exhibiting the specific characteristic is determined on the output side of the relevant controller are the relevant actuators and/or sensors and/or loads enabled to receive or execute the control signals fed to them by the controller. This can indeed guarantee a high level of security for an electrical domestic appliance; however this method and this circuit arrangement cannot be operated with a continuous signal and a pulse signal, i.e. with a single pulse.

The underlying object of the invention is thus to show a way in which, with a method and a circuit arrangement of the type given at the outset, actuators and/or sensors and/or loads can be safely controlled by means of switch bodies in an especially simple yet still effective manner, so that two different signals are required to switch them to active and that only the absence of a specific control signal of the two control signals leads to their being switched to inactive and remaining inactive.

The object just outlined is inventively achieved by a method of the type given above by issuing a continuous signal and a pulse signal as control signals to a number of bistable control bodies corresponding to the number of the switch bodies which. only by the issuing of the said continuous signal and by the issuing of the pulse signal occurring during the issuing of the continuous signal, are put into a switched-on state in which the switch bodies are switched to active, and which merely by switching off of the said continuous signal are put into the switched-off state, in which the switch bodies are switched off, and are held in this switched-off state even if the relevant continuous signal is issued once again.

The advantage of the invention is that two control signals which occur independently of each other are required for the secure control of the actuators and/or sensors and/or electrical loads of an appliance and especially of a domestic appliance. Only the correct issuing of the two control signals, namely the continuous signal and the pulse signal, allows the bistable control bodies provided to be switched on and thereby the actuators and/or sensors and/or loads to be switched securely and effectively. To switch the relevant actuators, sensors or loads off again effectively and securely and to leave them in the switched-off state, it is sufficient merely to switch off the said continuous signal. The renewed sole issuing of the continuous signal then namely does not cause any renewed switching on of the bistable control elements. This means that, with the method in accordance with the invention, the conditions which the PECs mentioned above must satisfy are to be fulfilled.

Expediently the issuing of the pulse signal is monitored and only if it is issued with a duration which is less than a defined duration and if the said continuous signal is present are the said actuators, sensors or electrical loads effectively switched. The advantage of this is that an incorrect issuing of the pulse signal, especially as a continuous signal, can be detected and evaluated as a fault.

Preferably the continuous signal is monitored for correct issuing or for its presence. The advantage of this is that an incorrect activation of the respective bistable control bodies can be easily detected by the said continuous signal.

Preferably output signals issued by the two bistable control elements are also monitored as to whether they have been issued correctly. In an advantageous manner this enables the relevant bistable control elements to be also included in the functional monitoring.

In accordance with a further expedient embodiment of the method in accordance with the invention the issuing of the pulse signal, of the continuous signal and of the output signals of the bistable switch bodies is monitored in a controller, through which only with a correct occurrence of the pulse signal of the continuous signal and of the output signal of the bistable switch bodies are the actuators, sensors and/or loads effectively controlled. This produces the advantage of an especially effective monitoring of the said signals. The signals concerned can namely by monitored for their correct occurrence with one and the same monitoring device. The object specified above is further achieved in accordance with of the present invention by a circuit arrangement used to carry out the method in accordance with the invention and for secure control of electrical actuators, sensors and/or loads, especially in domestic appliances and which features at least two corresponding switch bodies operated in accordance with an AND logic gate for effective switching of the said actuators, sensors and/or loads by control signals acting on the switch bodies. This circuit arrangement is characterized in accordance with the present invention in that, for issuing the control signals, a continuous signal issuing device and a pulse signal issuing device are provided, which, at a number of bistable control elements corresponding to the number of the switch bodies. permit a continuous signal or a pulse signal to be issued, and that the bistable control elements, by issuing the said continuous signal and by issuing the said pulse signal while the relevant continuous signal is being issued, are able to be kept in a switched-on state, in which the switch bodies are able to be effectively switched and just by switching off the said continuous signal can be placed into a switched-off state, in which the switch bodies are effectively switched off and are kept in this switched-off state even if the relevant continuous signal is issued once again.

This produces the advantage of a relatively small circuit outlay overall for the effective activation of the said switch bodies and thereby of the actuators and/or sensors and/or loads. In addition the relatively small circuit outlay ensures that the relevant switch bodies and thereby the said actuators, sensors and/or loads can be effectively switched only when the continuous signal and the pulse signal are issued in the specified defined sequence and, after switch-off of the said continuous signal, go into the switched-off state and also remain in this state, i.e. they cannot be effectively switched again just by the issuing of the continuous signal concerned. This inventive circuit arrangement thus fulfills the conditions which are imposed on a protected electronic circuit (PEC), as has been defined at the start of this document.

The inventive ANDing of two switch bodies is especially represented by a series connection of these switch bodies. This series connection must only offer the desired functionality in the sense of the required AND logic gate but does not necessarily however imply a spatial proximity of the two switch bodies to each other. Such proximity can however be of advantage in respect of the constructive layout of the corresponding switching arrangement.

In accordance with an expedient development of the inventive switching arrangement considered here, a pulse signal monitoring device is provided through which monitoring of the pulse signal can be undertaken in such a way that only when a pulse signal is issued with a duration lasting less than a defined duration and if the said a continuous signal is present are the circuit elements able be effectively switched. In this way, it there is an error in the issuing of the pulse signal the effective switching of the said circuit elements can be suppressed in an especially simple manner.

Expediently a continuous signal supervision device is also provided which monitors the continuous signal issued by a continuous signal issuing device for correct issuing. Through this monitoring of the continuous signal issuing the security of the effective switching of the said circuit elements is advantageously increased even further.

Preferably the bistable switch bodies are connected on the output side to a monitoring device which monitors the issuing of the output signals to be issued in each case by the control elements concerned. This measure means that the bistable control elements are advantageously included in the signal monitoring such that the effective control of the said switch bodies can only take place if the bistable control elements are also issuing correct output signals.

Preferably the above-mentioned monitoring devices are contained in a common controller which is preferably a microcomputer or microcontroller with associated software or is embodied by the latter. This brings with it the advantage of an especially small outlay for the circuitry of the alarm monitoring devices.

In accordance with a further expedient embodiment of the invention the continuous signal issuing device is formed by a door switch contact of the said electrical appliance and the pulse signal issuing device is formed by a push button which can be actuated independently of the door switch contact. The independent actuation of door switch contact and push button ensures an especially high level of security in respect of the effective switching of the said circuit elements.

Expediently the electrical actuators and/or sensors and/or loads are connected along with the switch bodies to a relay circuit, which is able to be controlled by a controller, which is preferably the controller previously mentioned. This measure brings the advantage of a simple electrical isolation of the electrical actuators and/or sensors and/or loads from the switching devices and from the controller. Such an electrical isolation is frequently desirable or required for safety reasons since the actuators, sensors or loads usually operated at a relatively high AC mains voltage of 230V for example may not have any electrically-conductive connection with their activation circuit which is operated with a relatively low voltage of e.g. +5V.

Preferably each electrical actuator, sensor and/or load belongs to a separate relay. This produces the advantage of an especially simple activation of the respective electrical actuators, sensors and/or loads.

Two different circuit options are preferably provided for the connection of the switch bodies to the relay circuits. In accordance with one circuit option the switch bodies are connected to the supply circuits which jointly connect the relays associated with the electrical actuators and/or sensors and/or loads. In accordance with the other circuit option the switch bodies are jointly connected to contacts of the relays of the associated electrical actuators, sensors and/or loads and arranged with these contacts in supply circuits of the relevant electrical actuators, sensors and/or loads. In both cases the advantage of an especially low outlay in circuit technology for the activation of the electrical actuators, sensors and/or loads by the said switch bodies including the relay circuit is produced.

The bistable control elements are preferably each formed by a bistable circuit element, such as a bistable flip-flop or bistable electronic component. The advantage of this is an especially small outlay in circuit technology in respect of the implementation of the bistable control bodies.

Preferably the bistable control bodies are each constructed from semiconductor elements. The switch bodies are preferably formed by semiconductor elements. This produces the advantage of especially simple-to-construct bistable control bodies and switch bodies.

The invention will be explained in greater detail below based on embodiments which refer to drawings.

The drawings show

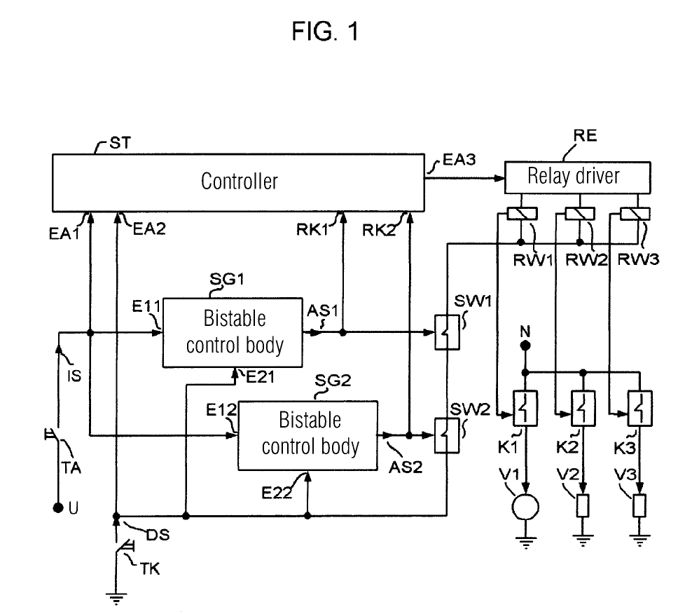

FIG. 1 a schematic circuit diagram of a basic layout of a circuit arrangement in accordance with a first embodiment of the invention,

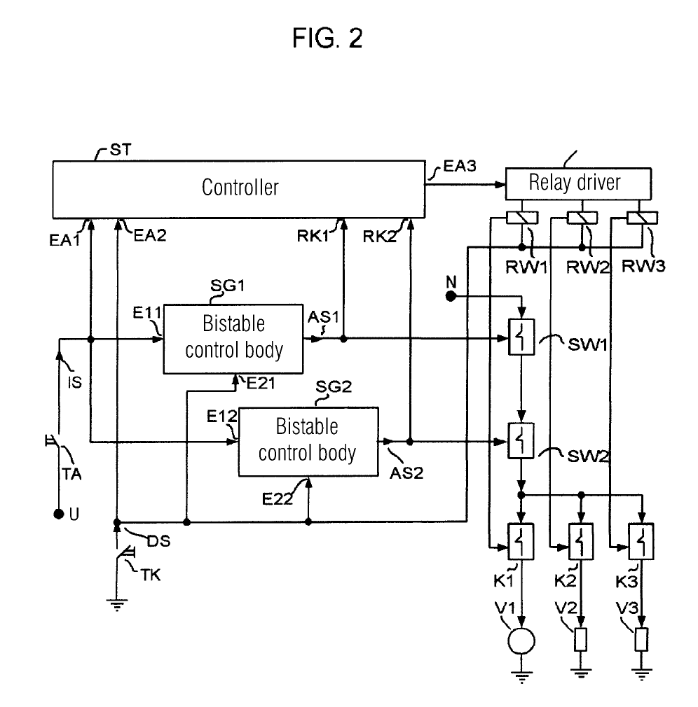

FIG. 2 a schematic circuit diagram of a variation of the circuit arrangement shown in FIG. 1 in accordance with a second embodiment of the invention,

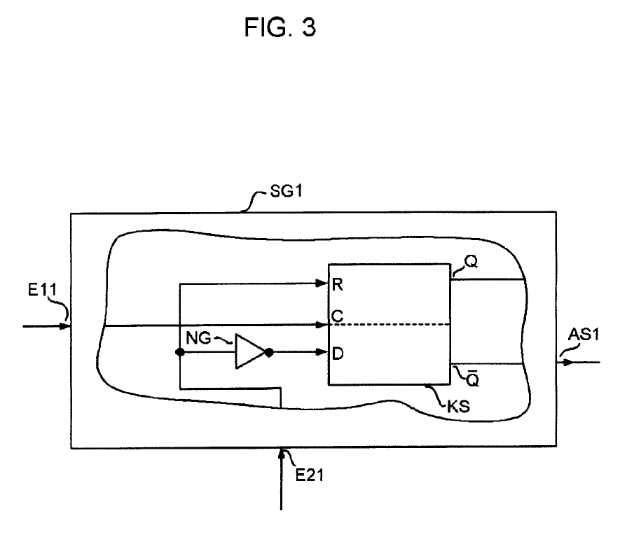

FIG. 3 a schematic circuit diagram of a possible layout of a bistable control element, as is used in the circuit arrangement in accordance with FIGS. 1 and 2, and

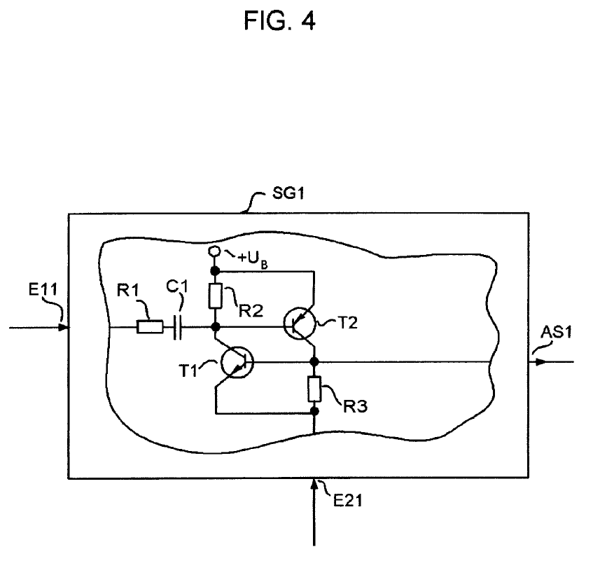

FIG. 4 a schematic circuit diagram of another possible layout of a bistable control element, as is provided in the circuit arrangement in accordance with FIGS. 1 and 2.

Before examining the drawings in greater detail, it should be pointed out that elements which correspond to each other in all drawings are labeled with the same reference symbols.

The circuit arrangement shown in FIG. 1 is used for secure control of electrical actuators and/or sensors and/or loads, labeled in FIG. 1 as V1, V2 and V3. The actuators can for example be cutoff switches, reversing relays, etc. in electrical appliances, especially in electrical domestic appliances. The said electrical sensors can for example be temperature sensors, fill level or water level sensors, etc., as are especially provided in electrically-operated domestic appliances. The said electrical loads can for example be electric motors, heating resistances, etc., as are likewise contained in electrically-operated domestic appliances.

The electrical actuators and/or sensors and/or loads V1, V2, V3 mentioned above, as will become more evident below, are activated by at least two switch bodies SW1 and SW2 operated in accordance with corresponding AND logic gates by means of control signals acting on the switch bodies SW1 and SW2. As can be seen from FIG. 1, the two switch bodies SW1 and SW2, which can be embodied for example by semiconductor switches, are switched in series with their switching paths. In this case the switch body SW1 of the relevant series circuit is connected with its one switching path to the ends of the relay windings RW1, RW2 and RW3 of electromagnetic relays which are provided individually for the respective actuators or sensors or loads V1, V2, V3. Belonging to each of the relay windings RW1, RW2 and RW3 is a make contact K1, K2 or K3, via which the respective one end of the respective electrical actuator, sensor or load V1, V2, V3 is connected to a common circuit point N, which for example can carry a 50-Hz AC mains voltage of 230V. The other ends of the electrical actuators, sensors and/or loads V1, V2, V3 lie in the present case for example at mass or ground potential.

The relay windings RW1, RW2, RW3 mentioned above are connected with other, not yet mentioned ends to the output side of a relay driver RE, the structure of which is not shown in any greater detail here. This relay driver RE can for example be embodied by individual control transistors, the switching paths of which are connected individually with the above-mentioned relay windings RW1, RW2 or RW3 and the control electrodes of which are connected jointly with an input of the relay driver RE indicated in FIG. 1. The relevant input of the relay driver RE is connected to an output EA3 of a controller ST which will be discussed in greater detail below. The previously mentioned control transistors can be connected to their switching path electrodes which are not connected to the relay windings RW1, RW2 or RWS3, for example to a point in the circuit carrying a DC voltage of +5V.

In the circuit arrangement shown in FIG. 1 the switch body SW2 of the series circuit consisting of the two switch bodies SW1 and SW2 is connected with its one switching path connection to a terminal of a contact TK representing a continuous signal issuing device, the other terminal of which is at ground or mass. This contact TK can for example be a door contact of an electrically-operated washing machine or of an electrically-operated tumble dryer, which is closed when the door is closed and in this condition issues a continuous signal (mass or ground potential). This continuous signal DS is then in FIG. 1 at the lower end of the switch body SW2; Only then can it excite the relay windings RW1, RW2 and RW3 considered above, if the two switch bodies SW1 and SW2 corresponding to an AND logic gate are actuated, i.e. closed. This is however not yet the case at this point in time.

The switch bodies SW1 and SW2 are connected with their actuation inputs to outputs AS1 or AS2 of two bistable control bodies SG1 or SG2. These bistable control bodies SG1 and SG2 are generally provided in a number corresponding to the number of the switch bodies SW1, SW2. As mentioned above this number amounts to at least two, and it is also two in this example.

The bistable control bodies SG1 and SG2 shown in FIG. 1 each have two control inputs on their input side. Bistable control body SG1 has the two control inputs E11 and E21 and bistable control body SG2 has the two control inputs E12 and E22. The two control inputs E21 and E22 of the two bistable control bodies SG1 and SG2 are connected to the previously mentioned door contact TK of the electrical appliance which represents a continuous signal issuing device, in which the overall circuit arrangement is used. The other two control inputs E1 1 and E12 of the two bistable control bodies SG1 and SG2 are connected to a pulse signal issuing device TA, which in accordance with FIG. 1 is embodied by a pushbutton TA, via which the relevant control inputs E11 and E12 of the two bistable control bodies SG1 and SG2 are connected to a circuit point U which can conduct a voltage of for example +2.7V. The relevant pushbutton TA is in this case able to be actuated independently of the previously mentioned door contact TK and is naturally also arranged separately from the door contact. By actuating the pushbutton TA a pulse signal IS is issued in the form of a single voltage pulse of for example +2.7V. This pulse signal thus involves a single pulse which, if the pushbutton TA is operating correctly, has a specific duration which lies below a defined duration.

The pushbutton TA issuing the said pulse signal IS when actuated and the door contact TK issuing the said continuous signal DS in its closed state are connected to input terminals EA1 or EA2 of the already mentioned controller ST, which can for example be a microcontroller with its own software. In this controller ST the pulse signal IS and the continuous signal DS are monitored for their correct occurrence. As regards the pulse signal IS, monitoring is carried out as to whether this occurs with a duration lying below a defined duration, and as regards the continuous signal DS monitoring is carried out as to whether this is occurring at all. Monitoring the pulse signal IS thus enables it to be established whether the pushbutton TA is operating correctly or whether, as a result of an error, it is not delivering any pulse signal IS at all or also a continuous signal, for example as a result of what is known as freezing.

The previously considered controller ST has two further input terminals, designated RK1 and RK2. Of these input terminals, input terminal RK1 is connected to an output terminal AS1 of the bistable control body SG1, which is connected to the actuation input of the above mentioned switch body SW1. The other input terminal RK2 of the controller ST is connected to the output terminal AS2 of bistable control body SG2, which is connected to the actuation input of switch body SW2. The connections between the output terminal AS1 of bistable control body SG1 and the output terminal AS2 of bistable control body SG2 with previously-mentioned input terminals RK1 or RK2 of the controller ST represent so-called return channel connections, via which the controller ST monitors the occurrence of output signals at the said output terminals AS1 and AS2 of the two bistable control bodies SG1 or SG2. This monitoring takes place like the monitoring of the signals occurring at the input terminals EA1 and EA2 of the controller ST by monitoring devices forming parts of the controller ST. These monitoring devices can however be implemented by software in the controller ST especially formed by a microcontroller with its own software.

Now that the structure of the circuit arrangement shown in FIG. 1 has been explained sufficiently for an understanding of the information disclosed above, the method of operation of this circuit arrangement will now be considered in more detail. Let the initial assumption be that both the door contact TK and also the pushbutton TA are opened. In this case the entire circuit arrangement is in the idle or initial state, in which the bistable control bodies SG1, SG2 are in their switched-off or reset state and in which the switch bodies SW1 and SW2 are opened and in which no power is supplied to the electrical actuators and/or sensors and/or loads V1, V2, V3.

If the pushbutton TA is now actuated, a pulse signal IS is applied to the bistable control bodies SG1 and SG2 and the controller ST, but this does not have any further effects however. The circuit arrangement shown remains in its previously-stated idle or initial state. Even if just the door contact TK alone is initially closed and remains closed, the idle or initial state of the circuit arrangement shown in FIG. 1 is maintained unchanged. If however the pushbutton TA is additionally actuated with the door closed—which thus acts as a start button—and thus a pulse signal IS is issued, the two bistable control bodies SG1 and SG2 go into the respective switched-on or set state. A renewed single or multiple actuation of the pushbutton TA also has no further effect on the state of the bistable control bodies SG1 and SG2 thus reached.

In the set state now reached the two bistable control bodies SG1 and SG2 output such an output signal in each case from their output terminals AS1 or AS2, such as an output signal of e.g. +2.7V corresponding to a binary signal “1”, so that the switch body SW1 or SW2 connected to its respective output terminal AS1 or AS2 by its control input is closed. This means that the ends of the relay windings RW1, RW2 and RW3 connected to the series circuit of the switch bodies SW1 and SW2 now obtain mass or ground potential from the closed control contact TK and go into their excited state, provided the relay driver RE is supplied on its input side from output terminal EA3 of the controller ST with a control signal (for example a binary signal “1”) indicating the correct state of the monitoring signal. As a result of the excitation of the relay windings RW1, RW2 and RW3, the relay contacts K1, K2 or K3 associated with these windings are closed, and thus the mains voltage from the switching point N is applied to the electrical actuators and/or sensors and/or loads V1, V2 and V3. The relevant actuators, sensors or loads V1, V2, V3 will thus be activated.

If the door contact TK is now opened again, the issuing of the continuous signal DS stops, i.e. the ground or mass potential via this control contact TK. The only result of this is that the relay windings RW1, RW2 and RW3 of the relay circuit are de-excited, but above all also that the bistable control bodies SG1, SG2 go back into their switched-off or reset state, in which the switching paths of the switch bodies SW1 and SW2 are opened again. The electrical actuators and/or sensors and/or loads V1, V2, V3, as a result of the now opened relay contacts K1, K2 and K3, are again disconnected from the mains voltage at circuit point N and thereby deactivated.

A renewed actuation—either intentional or unintentional—of the door contact TK should not result in any renewed activation of the electrical actuators, sensors or loads V1, V2 and V3 just activated, nor does it result in any such activation. The sole delivery of the continuous signal DS by the closed door contact TK does in fact not put the bistable control bodies SG1 and SG2 back into their switched-on or set state. Instead this requires the additional issuing of a pulse signal IS of the defined duration by the pushbutton TA to be actuated again. However while this pushbutton TA is not actuated, the bistable control bodies SG1 and SG2 remain in their switched-off or reset states, and thus the electrical actuators, sensors or loads V1, V2, V3 cannot be activated.

While in the circuit arrangement shown in FIG. 1 the switch bodies SW1, SW2 are jointly connected to the feed circuits of the relays associated with the electrical actuators and/or sensors and/or loads V1, V2, V3, more accurately with their relay windings RW1, RW2 and RW3, FIG. 2 shows a modification of the connection of the switch bodies SW1, SW2 to the relevant relays. In accordance with FIG. 2 the switch bodies SW1, SW2 are in fact jointly connected to the relay contacts K1, K2, K3 of the relays or relay windings RW1, RW2, RW3 associated with the electrical actuators, sensors or loads V1, V2, V3 and arranged with these contacts in circuits of the relevant actuators, sensors or loads V1, V2, V3. In relation to the circuit arrangement shown in FIG. 1, this means that those ends of the relay windings RW1, RW2, RW3 which are not connected to the relay driver RE, are connected directly to the control contact TK and that the series circuit of the two switch devices SW1 and SW2 is inserted into the connecting line between the common connection point of the relay contacts K1, K2, K3 and the circuit point N conducting the mains voltage. The remaining structure of the circuit arrangement shown in FIG. 2 fully corresponds to the circuit arrangement depicted in FIG. 1, which is why this circuit structure is not explained in any greater detail here. The method of operation of the circuit arrangement shown in FIG. 2 regarding the bistable control bodies SG1 and SG2 from switched-off or reset states into their switched-on or set states and regarding the active/inactive switching of the electrical actuators, sensors or loads V1, V2, V3 completely corresponds to the method of operation of the circuit arrangement shown in FIG. 1. Accordingly a separate explanation of the method of operation of the circuit arrangement shown in FIG. 2 can be dispensed with here.

Two possible forms of realization of bistable control bodies SG1 and SG2 in the circuit arrangements provided for in accordance with FIGS. 1 and 2 are explained below. Since these bistable control bodies SG1 and SG2 can be identical in their construction and are normally also identically constructed, only one possible structure of the bistable control body SG1 is examined in greater detail with reference to FIGS. 3 and 4.

In accordance with FIG. 3 the bistable control body SG1 contains a bistable flip-flop KS, which is preferably a D-type bistable flip-flop, as is for example provided by the bistable flip-flop with the designation 74LVC1G74. This bistable flip-flop GS features an input terminal or data terminal D which is connected via a negator or NOT element NG to the input terminal E21 of the bistable flip-flop SG1 and to which the continuous signal DS in accordance with FIGS. 1 and 2 is thus fed. Further the relevant bistable flip-flop KS features a reset input R, which in the present case is connected to the input terminal E21 of the bistable control body SG1. In addition the bistable flip-flop KS features a clock input C, which is connected to the input terminal E1 1 of the bistable control body SG1, i.e. with the control input to which the pulse signal IS in accordance with FIGS. 1 and 2 is fed. On the output side the bistable flip-flop KS has two outputs Q and Q̅, of which in the present case the output Q̅ is connected to the output terminal AS1 of the bistable control body SG1.

The method of operation of the bistable control body SG1 shown in FIG. 3 is considered briefly below. The sole supply of a signal—in the present case of the pulse signal IS specified in connection with FIG. 1—at input terminal E1 1 and thereby at clock input C of the bistable flip-flop KS can only cause this same bistable flip-flop to be set in accordance with the input signal present at the input terminal E21 of the bistable control body SG. If this input terminal E21 is not supplied with a mass or ground potential corresponding to a binary signal “0”—the continuous signal DS, since the door contact TK for the circuit arrangement in accordance with FIG. 1 or in accordance with FIG. 2 is still open, the reset input D of the bistable flip-flop KS in the bistable control body SG1 will in this case be supplied with a potential corresponding to a binary signal “1” and the input of the relevant bistable flip-flop KS will be fed a potential corresponding to a binary signal “0”. Through this binary signal the bistable flip-flop KS is put into its reset state if it is not already in this reset state. In this case the bistable flip-flop KS outputs from its output Q an output signal corresponding to a binary signal “1” and from its output Q̅ an output signal corresponding to a binary signal “0”.

If however in the previously assumed reset state of the bistable flip-flop KS only the input terminal E21 of the bistable control body SG1 is supplied with a mass or ground potential corresponding to a binary signal “0” in the form of the continuous signal DS, then at the input or data terminal D of the bistable flip-flop KS there is a signal corresponding to a binary signal “1”, and at the reset input R of this flip-flop KS lies a potential corresponding to a binary signal “0”. This alone however does not have any effect on the setting state of the bistable flip-flop KS. Only if now, i.e. during the issuing of the said continuous signal DS, a pulse signal IS (“1”) occurs at the input terminal Ell of the bistable control body SG1 and thus at the clock input T of the bistable flip-flop KS, will its setting state be changed to the set state, in which from the output terminal Q̅ of this bistable flip-flop KS an output signal corresponding to a binary signal “1” is issued which leads to the closure of the associated switch body SW1. A subsequent renewed single or multiple occurrence of the said pulse signal IS at the input terminal E11 does not change the setting state of the bistable flip-flop KS reached. Only when the continuous signal DS (“0”) supplied to the input terminal E21 disappears again will the reset input R of the bistable flip-flop KS be supplied a signal corresponding to a binary signal “1”, as a result of which this bistable flip-flop KS goes back into its reset state even without a pulse signal IS and thus also without a clock signal at its clock input C, in which a potential corresponding to a binary signal “1” is issued from its output terminal Q and a potential corresponding to a binary signal “0” is issued from its output terminal Q̅, as a result of which the associated switch body SW1 is opened again.

If subsequently only the input terminal E21 is supplied with the continuous signal (“0”) again, this has no effect on the setting state of the bistable flip-flop KS—it remains in its reset state. Thus this circuit arrangement also meets the requirements imposed on a protected electric circuit (PEC) as has been explained at the start of this document.

The form of realization of the bistable control body SG1 shown in FIG. 4 shows an equivalent circuit of a thyristor, consisting of two bipolar transistors coupled to each other, namely a transistor T1 of the npn conducting type and a transistor T2 of the pnp conducting type. in this figure the transistor T1 is connected with its base to the collector of the transistor T2, which in its turn is connected with its base to the collector of transistor T1. The common connection point of the collectors of the transistor T1 and base of the transistor T2 is linked via a series RC element, consisting of an ohmic resistor R1 and a capacitor C2 to the input terminal E11 of the bistable control body SG1. In addition the common connection point just mentioned between the collector of the transistor T1 and the base of the transistor T2 is connected via an ohmic resistor R2 to a circuit point +UB carrying a positive supply voltage of for example +5V, to which the emitter of the transistor T2 is also connected. The common connection point between the base of the transistor T1 and the collector of the transistor T2 is one the one hand connected via an ohmic resistor R to the input terminal E21 and on the other if necessary directly to the output terminal AS1 of the bistable control body SG1. Finally the emitter of the transistor T1 is also connected to the input terminal E21 of the bistable control body SG1.

The method of operation of the circuit arrangement of the bistable control body SG1 shown in FIG. 4 is explained briefly below. If one or more pulse signals IS is fed to the input terminal E11 of the bistable control body SG1 shown in FIG. 4, as has been mentioned with reference to FIGS. 1 and 2, this has no effect provided the input terminals E21 of the bistable control body SG1 is not supplied with any continuous signal DS in the form of a mass or ground potential. The equivalent thyristor circuit shown with the two transistors T1 and T2 remains in its initial state, in which both transistors T1, T2 are non-conducting.

If on the other hand without the previously-mentioned pulse signal IS only a continuous signal DS is fed to the input terminal E21 of the bistable control body. as has been mentioned with reference to FIGS. 1 and 2, this continuous signal DS also does not cause any changes in the conductive state of the two transistors T1 and T2. If however this continuous signal DS, i.e. in the present case mass or ground potential, is supplied to the input terminal E21 and if simultaneously the input terminal E11 of the bistable control body SG1 is supplied with a pulse signal IS in accordance with FIGS. 1 and 2, the differentiating effect through the RC element R1, C1 forming a differential element leads to the thyristor equivalent circuit consisting of the transistors T1 and T2 being ignited to a certain degree. This means that the two transistors T1 and T2 now go into the conducting state, in which corresponding potential (“1”) corresponding to the potential “1” at the circuit point +UB is issued from the common connection point of the collector of the transistor T2 and the base of the transistor T1 and thereby from the output terminal AS1 of the bistable control body SG1, as a result of which the switch body SW1 linked to the output terminal AS1 is switched on or through connected.

This last-mentioned state of the thyristor equivalent circuit and thereby that of the switch body SW1 remains independent of the occurrence or non-occurrence of further pulse signals IS at the input terminal E11 of the bistable control body SG1 until such time as the continuous signal (mass or ground potential) disappears again at terminal E21 of the bistable control body SG1. In this case the two transistors T1 and T2 go back again into their non-conducting state in accordance with FIG. 4.

In this last-mentioned state—in which the two transistors T1 and T2 are each in the non-conducting state—just the return of the continuous signal DS, i.e. of mass or ground potential to input terminal E21, does not lead to the two transistors T1 and T2 going back into the conductive state. This means that this circuit arrangement also fulfills the requirements imposed on a protected electronic circuit (PEC), as has been explained at the start of this document.

Finally it should also be noted here that the bistable control body SG1, SG2 can also be implemented in a way other than that explained with reference to FIGS. 3 and 4. Thus the relevant bistable control bodies SG1, SG2 can be implemented for example by other bistable flip-flops or by normal quench thyristors or triacs, provided these bistable control bodies operate in the way explained above when supplied with a continuous signal and a pulse signal in the described manner.

### LIST OF REFERENCE SYMBOLS

AS1, AS2 Output terminal
C Clock input
C1 Capacitor
D Input or data terminal
DS Continuous signal
E11, E12, E21, E22 Input terminal
EA1, EA2 Input terminal
EA3 Output terminal
IS Pulse signal
K1, K2, K3 Relay contact
KS Bistable flip-flop
N Circuit point
NG Negator or NOT element
Q, Q̅ Output terminal
R Reset input
R1, R2, R3 Ohmic resistor
RE Relay driver
RK1, RK2 Input terminal
RW1, RW2, RW3 Relay winding
SG1, SG2 Bistable control body
ST Controller
SW1, SW2 Switching device
T Clock input
T1, T2 Transistor, bipolar transistor
TA Pulse signal issuing device
TK Continuous signal issuing device, door contact
U Circuit point
+UB Circuit point
V1, V2, V3 Electrical actuator and/or sensor and/or load

1-19. (canceled)

20. A method for secure control of one of actuators, sensors, and loads in an electrical domestic appliance including at least two switch bodies operated in accordance with an AND logic gate for effective switching of the one of actuators, sensors, and loads by control signals acting on the at least two switch bodies, the method comprising:
issuing a continuous signal and a pulse signal as control signals to a number of bistable control bodies corresponding to a number of the at least two switch bodies,
switching the number of bistable control bodies into a switched-on state, in which the at least two switch bodies are effectively switched, only by the issuing of the continuous signal and by the issuing of the pulse signal which occurs during the issuing of a relevant continuous signal,
switching the at least two switch bodies into a switched-off state, in which the switch bodies are switched off, solely by switching off the continuous signal, and
maintaining the at least two switch bodies in the switched-off state even if the relevant continuous signal is issued once more.

21. The method as claimed in claim 20, comprising:
monitoring the issuing of the pulse signal and effectively switching the one of the actuators, sensors, and loads only if the pulse signal is issued with a duration lying below a defined duration and if the continuous signal is present.

22. The method as claimed in claim 20, comprising:
monitoring whether the continuous signal is being issued correctly and whether the continuous signal is present.

23. The method as claimed in one of the claim 20, comprising:
monitoring whether output signals issued by the bistable control bodies are being issued correctly.

24. The method as claimed in claim 23, comprising:
monitoring the issuing of the pulse signal, the continuous signal, and the output signals of the bistable control bodies in a controller, and
effectively controlling the one of the actuators, sensors, and loads by the switch bodies only upon correct occurrence of the pulse signal, the continuous signal, and the output signals of the bistable control bodies.

25. A circuit arrangement for executing a secure control of one of actuators, sensors, and loads in an electrical appliance containing these components, the circuit arrangement comprising:
at least two switch bodies operated in accordance with an AND logic gate for effective switching of the one of the actuators, sensors, and loads by control signals acting on the at least two switch bodies;
a pulse signal issuing device and a continuous signal issuing device for issuing a control signal,
wherein one of the pulse signal issuing device and the continuous signal issuing device issue one of a pulse signal and a continuous signal to a number of bistable control bodies corresponding to a number of the at least two switch bodies, and
wherein the bistable control bodies are switched into a switched-on state, in which the at least two switch bodies are effectively switched, by the issuing of the continuous signal and of the pulse signal,
wherein the at least two switch bodies are switched into a switched-off state, in which the at least two switch bodies are effectively switched off, solely by switching of the continuous signal, and are kept in the switched-off state even on renewed issuing of a relevant continuous signal.

26. The circuit arrangement as claimed in claim 25, comprising:
a pulse signal monitoring device that monitors the pulse signal such that the at least two switch bodies are effectively switched only by issuing a pulse signal with a duration lying below the defined duration and if the continuous signal is present.

27. The circuit arrangement as claimed in claim 25, comprising:
a continuous signal monitoring device that monitors whether the continuous signal issued by the continuous signal issuing device is being correctly issued.

28. The circuit arrangement as claimed in one of the claim 25, wherein the bistable control bodies are connected on an output side of the bistable control bodies to a monitoring device, which monitors the issuing of output signals to be issued by each relevant bistable control body.

29. The circuit arrangement as claimed in claim 26, wherein the monitoring devices are included in a common controller.

30. The circuit arrangement as claimed in claim 29, wherein the common controller includes a microcontroller.

31. The circuit arrangement as claimed in claim 25, wherein the pulse signal issuing device is formed by a pushbutton, and
wherein the continuous signal issuing device is formed by a door switch contact of the electrical appliance configured to be actuated independently of the pushbutton.

32. The circuit arrangement as claimed in claim 25, wherein the one of the actuators, sensors, and loads are connected along with the at least two switch bodies to a relay circuit which is controlled by a controller.

33. The circuit arrangement as claimed in claim 32, wherein a separate relay belongs to each of the one of the actuators, sensors, and loads.

34. The circuit arrangement as claimed in claim 33, wherein the at least two switch bodies are jointly connected to supply circuits of the separate relays associated with the one of the actuators, sensors, and loads.

35. The circuit arrangement as claimed in claim 33, wherein the at least two switch bodies are jointly connected to contacts of the separate relays associated with the one of the actuators, sensors, and loads and are arranged with these contacts in supply circuits of a relevant one of the actuators, sensors, and loads.

36. The circuit arrangement as claimed in claim 25, wherein the bistable control bodies are each formed by a bistable switch body.

37. The circuit arrangement as claimed in claim 36, wherein the bistable control bodies are each constructed from semiconductor elements.

38. The circuit arrangement as claimed in one of the claim 25, wherein the switch bodies are formed by semiconductor elements.

39. The method as claimed in claim 20, wherein the electrical appliance is an electrical domestic appliance.

40. The circuit arrangement as claimed in claim 25, wherein the electrical appliance is an electrical domestic appliance.

41. The circuit arrangement as claimed in claim 25, wherein the switched-on state is a set state.

42. The circuit arrangement as claimed in claim 25, wherein the switched-off state is a reset state.
